(19) United States
(12) Patent Application Publication
(10) Pub. No.: US 2014/0138881 A1
(43) Pub. Date: May 22, 2014

(54) GAS ASSISTED IMPRINT SYSTEM AND THE MANUFACTURING PROCESS THEREOF

(71) Applicant: NATIONAL TAIWAN UNIVERSITY OF SCIENCE AND TECHNOLOGY, Taipei City (TW)

(72) Inventors: Fuh-Yu Chang, Taipei City (TW); Ping-Tun Teng, Taipei City (TW)

(73) Assignee: NATIONAL TAIWAN UNIVERSITY OF SCIENCE AND TECHNOLOGY, Taipei City (TW)

(21) Appl. No.: 13/903,705

(22) Filed: May 28, 2013

(30) Foreign Application Priority Data
Nov. 16, 2012 (TW) 101142722

(51) Int. Cl. B29C 43/12

(52) U.S. Cl. CPC B29C 43/12
USPC 264/553; 425/405.2

(57) ABSTRACT

The present invention discloses a gas assisted imprint system and the manufacturing method thereof. More specifically, instead of utilizing a rigid platform to, the gas assisted imprint system and the manufacturing method of the present invention utilizes a film to support the work-piece so as to evenly apply a force to the surface by the deformation caused by pressurized gas. More specifically, one of the main features of the present invention is that the present invention utilizes two films to cover the surfaces of a work-piece and applies a force evenly thereto by deforming the films by high pressure fluid. Accordingly, the present invention is capable of pressing the irregular surface of the work-piece evenly, solving the long lasted problem of the prior art.

### PRIORITY CLAIM

This application claims the benefit of the filing date of Taiwan Patent Application No. 101142722, filed Nov. 16, 2012, entitled “GAS ASSISTED IMPRINT SYSTEM AND THE MANUFACTURING PROCESS THEREOF,” and the contents of which is hereby incorporated by reference in its entirety.

### FIELD OF THE INVENTION

The present invention discloses a gas assisted imprint system and the manufacturing process thereof, more specifically, the present invention discloses a gas assisted imprint system and the manufacturing process that capable of applying pressure onto the various surface of an irregular work-piece evenly by utilizing a flexible film to load the work-piece instead of the rigid platform of prior art.

### BACKGROUND OF THE INVENTION

In the micro/nano scale imprint process, gas assisted imprint process is widely used to improve the quality thereof. The gas assisted imprint process utilizes a gas form material to press a film/sheet shaped mold, having a micro/nano scale pattern form on the surface thereof, toward the surface of a work-piece so as to form a corresponding pattern thereon. By the continuous deformation property of gas, a well distributed pressure may be applied onto the surface of the work-piece via the deformed film.

Please refer to the FIG. 1, the FIG. 1 depicts a schematic view of a well known gas assisted soft mold imprint system. In the figure, it is clearly shown that the system is essentially composed of a cover, a platform, a work-piece, a film P1, a pressure source P3 and a hydraulic device P4. The cover and the platform are fixed tightly mutually to form a chamber therein.

While in practice, the work-piece is firstly disposed onto the platform, after that, the hydraulic device P4 is utilized to provide a vertical force to the platform so as to clip and fix the film P1 between the cover and the platform. Then, the heating board P2 connected with the cover is utilized to heat the work-piece, the carrier and the cover so as to provide a high temperature environment to soften the film. Subsequently, a pressurized gas is inputted into the air tighten spacing without the work-piece disposed therein so as to apply an even force to the work-piece by deforming the film P1 toward the work-piece. Meanwhile, part of the surface of the work-piece is covered by the film and the chamber is divided into two different airtight spacing.

By the said art, since the at least part of the work-piece is necessarily contact with the rigid platform, the at least part of the work-piece shall not able to be covered by the film and be formed a pattern thereon by the imprint process.

Accordingly, it is a problem to be solved to develop a process which is capable of applying pressure evenly to at least most or even all of the surface of an irregular shaped work-piece so as to form a predetermined pattern thereon by imprint process.

### SUMMARY OF THE INVENTION

One object of the present invention is to provide a gas assisted imprint system, utilized to process an imprint process to a work-piece, the gas assisted imprint system comprising a first chamber and a second chamber. The first chamber connects with a first pressure source, the first chamber has a first opening covered with a first flexible film so as to seal the first chamber. The second chamber connects with a second pressure source, the second chamber has a second opening covered with a second flexible film so as to seal the second chamber; wherein, while in practice, part of the first flexible film contacts with the second flexible and form an accommodating spacing therebetween for accommodating the work-piece. Furthermore, the accommodating spacing may be airtight to the first chamber and the second chamber by the first film and the second film and connected to a third pressure source.

Moreover, the first pressure source and the second pressure source may provides a positive pressure to the first chamber and the second chamber respectively, while the third pressure source may provides a negative pressure to the third chamber. Furthermore, by applying the positive pressure to the first chamber and the second chamber, the first flexible film and the second flexible film are deformed toward each other. Meanwhile, a positive pressure is applied to each of the corresponding surface of the working-piece while the first flexile film and the second flexile film are contacted with each other. Furthermore, the forces applied on the surface of the working-piece by the first flexible film and the second flexible film are both smaller than the average yield strength of the working-piece respectively.

Furthermore, the another object of the present invention is to provide a gas assisted imprint manufacturing process, which the said process comprises the following steps of: providing (preparing) providing a work-piece; providing a first chamber, connected to a first pressure source, the first chamber having a first opening; providing a second chamber, connected to a second pressure source, the second chamber having a second opening; providing a first film; providing a second film; sealing the first chamber by covering the first opening by the first film; sealing the second chamber by covering the second opening by the second film so as to form an accommodating spacing between the first flexible film and the second flexible film for accommodating the work-piece therein; disposing the work-piece into the accommodating spacing; and utilizing the first pressure source and the second pressure source to respectively provide a positive pressure to the first chamber and the second chamber for deforming and connecting the first flexible film and the second flexible film so as to process the imprint process by respectively applying a pressure to the surface of the work-piece.

While in actual practice, the said accommodating spacing may be an airtight chamber and may be air tighten and connected to a third pressure source. Furthermore, the first pressure source and the second pressure source respectively provides a positive pressure, the third pressure source provides a negative pressure, wherein the force applied on the surface of the working-piece by the first flexible film and the second flexible film is smaller than the average yield strength of the working-piece respectively.

In summary, the present invention utilizes a film to support the work-piece so as to evenly apply a force to the surface thereof by the deformation of the films caused by pressurized gas. More specifically, one of the main features of the present invention is that the present invention utilizes two films to cover the surfaces of a work-piece and applies a force evenly thereto by deforming the films by high-pressure fluid. Accordingly, the present invention is capable of applying a pressure to the irregular surface of the work-piece evenly, solving the long lasted problem of the prior art.

On the advantages and the spirit of the invention, it can be understood further by the following invention descriptions and attached drawings.

### BRIEF DESCRIPTION OF THE DRAWINGS

FIG. 1 depicts a schematic view of a well-known gas assisted soft mold imprint system.

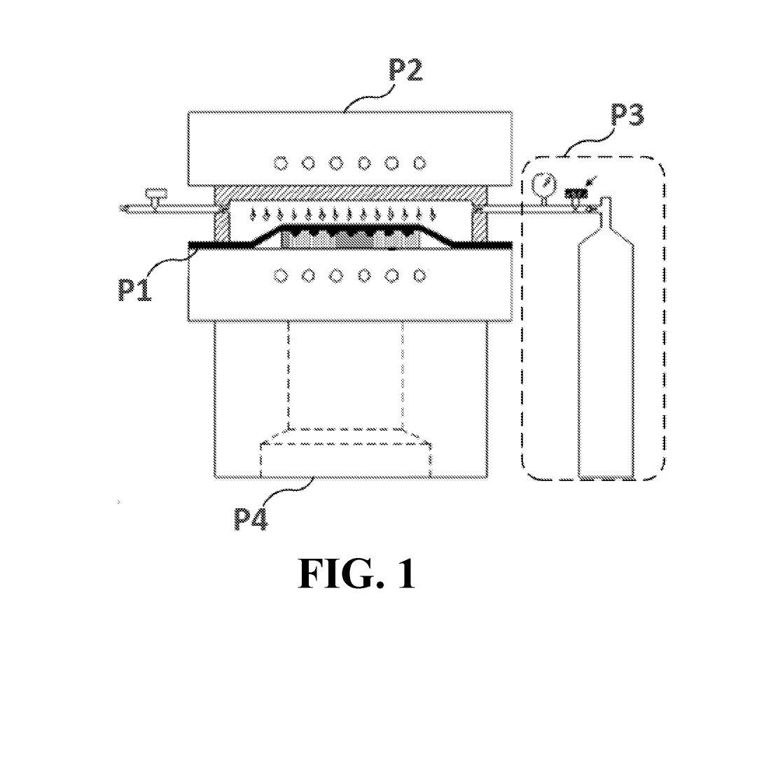

FIG. 2A and FIG. 2B respectively depicts a schematic view of a preferred embodiment of the gas assisted imprint system of the present invention.

FIG. 3A and FIG. 3B respectively depicts a schematic view of another embodiment of the gas assisted imprint system of the present invention.

### DETAILED DESCRIPTION

For overcoming the said problem exists in the prior art, the present invention discloses a novelty gas assisted imprint system capable of evenly adding pressure to an outer surface of an arbitrary shaped work-piece. More specifically, the system of the present invention can further be performed on a nano-imprint process so as to form a nano or micro scale pattern on the surface of the work-piece. More specifically, one of the main features of the present invention is to provide a gas assisted imprint system and the manufacturing process thereof utilizing a film to load a work-piece thereon so as to apply a force evenly to the lower surface of the work-piece.

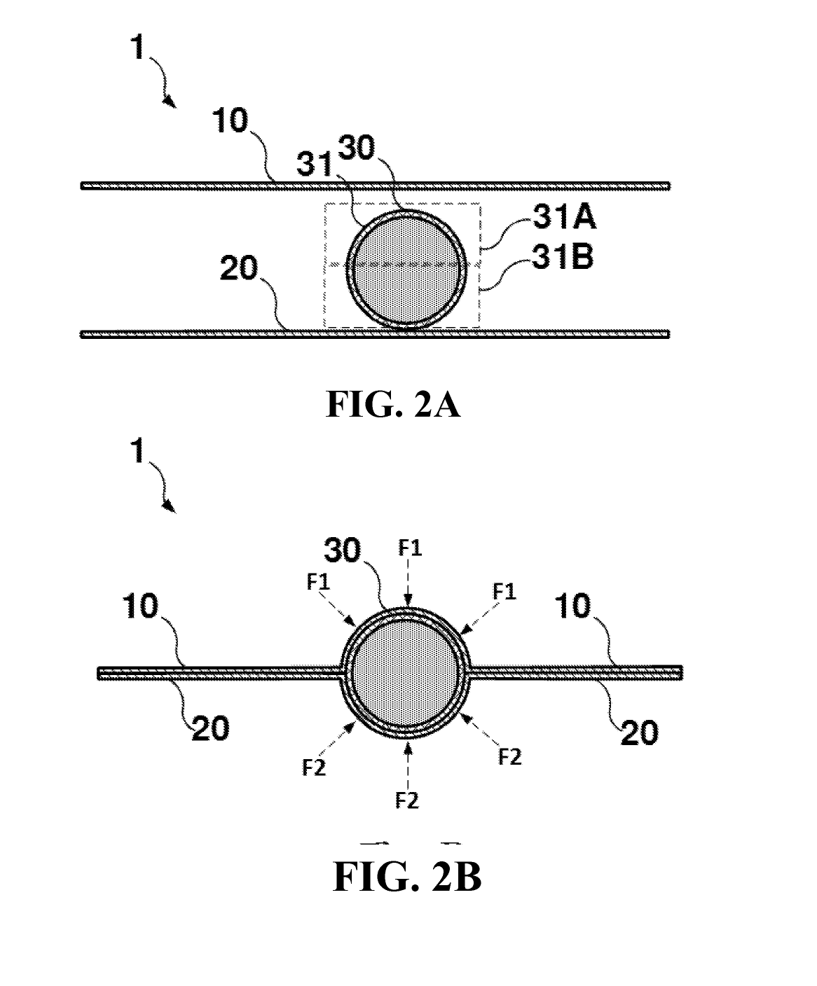

For clarity, please refer to FIG. 2A and FIG. 2B, FIG. 2A and FIG. 2B respectively depicts a schematic view of a gas assisted imprint process of the present invention of a preferred embodiment. By omitting the secondary features, it is clearly shown that the present invention is essentially composed of a work-piece 30, a first film 10 and a second film 20. The second film 20 is disposed under the work-piece 30 so as to load and support the work-piece 30 thereon, the first film 10 is disposed at the another side of the work-piece 30 corresponding to the second film 20. While in practice, the first film 10 and the second film 20 can respectively be deformed by a pressured fluid so as to cover the corresponding surface of the work-piece 30 and applying a force thereto evenly. In the figures, only one work-piece is illustrated, however, the present invention is capable of processing a plurality of work-piece 30 simultaneously and some of the work-pieces are omitted for the clarity of the specification.

It worth a mention that, the said work-piece 30 itself may be a mold having a pre-processing object or material disposed therein. Please refer to the FIG. 2A, in the present embodiment, the work-piece 30 is a hollow column shaped internal shrinking mold. While the pressure applied on the outer surface of the work-piece 30 via the first film 10 and the second film 20, the mold may be deformed inwardly toward the axial thereof so as to apply a force to the pre-processing object disposed therein in order to form a pattern onto the surface of the pre-processing object. More specifically, the said pattern may be a micro/nano scale structure. Furthermore, the shape of the work-piece 30 is not limited to the column or tube shaped as previously described, the work-piece 30 may also be cuboid or other 3D shaped structure, moreover, the 3D shaped structure may also comprises a curve or irregular boundary surfaces.

Furthermore, the external surface of the work-piece 30 is defined as an outer surface 31, the outer surface 31 of the work-piece 30 can be classified into a first side 31A and a second side 31B. Please refer to the FIG. 2A, the second side 31B of the work-piece 30 is loaded onto the surface of the second film 20.

Meanwhile, the first film 10 or the second film 20 may be a film or piece shaped material which can be deformed for a predetermined displacement without cracking. More specification, the first film 10 or the second film 20 of the present invention may, but not limited to be formed of polymeric material, for example, PET Film or Polyester Film. Furthermore, the first film 10 or the second film 20 may optionally has a predetermined pattern formed on the surface toward the work-piece 30 so as to be utilized to form a predetermined pattern on the corresponding surface of the work-piece. However, the first film 10 or the second film 20 of the present invention is not necessarily require the said predetermined pattern and the first film 10 or second film 20 and can only be a pressure applying means to the work-piece 30.

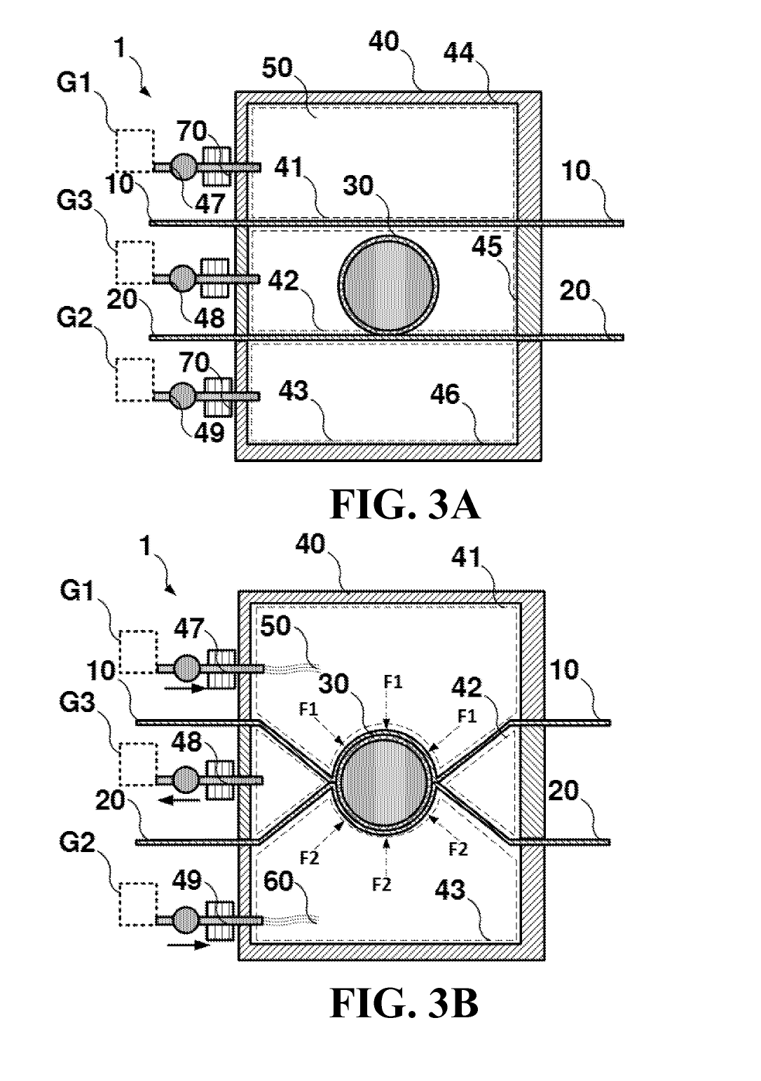

While in actual practice, the said system is preferred to be disposed in an airtight chamber as shown in the FIG. 3A and FIG. 3B. In the figures, the FIG. 3A and FIG. 3B respectively depicts a schematic diagram of the process during the process thereof. In the FIG. 3A, it is clearly shown that the present invention of gas assisted imprint system 1 may further comprises an air-tight chamber 40 so as to accommodate the said first film 10, second film 20 and the work-piece 30 therein. Moreover, the internal side of the chamber 40 has an upper surface 44, a lateral surface 45 and a lower surface 46 arranged from top to down. While the upper surface 44, the lateral surface 45 and the lower surface 46 of the chamber 40 may respectively corresponding to a detachable independent member, allowing the easy assembly of the first film 10 and the second film 20. More specifically, in the said design, the first film 10 and the second film 20 can be installed with the corresponding member before the assembly of the members. It worth a mention that the chamber 40 of the present invention may, or may not, be assembled by plurality of components as previously described.

In another way, before the gas assisted imprint manufacturing process begins, the first opening of the upper chamber 41 may be covered with the first film 10 and the second opening of the lower chamber 43 is covered with the second film 20.

As shown in FIG. 3A, the first film 10 and the second film 20 penetrated through both internal side and the external side of the chamber 40 allowing streamhandling in the mass-producing process. Furthermore, the said design allowing the first film 10 and the second film 20 to be fixed at the relative position of the chamber.

After installing the first film 10, the second film 20 with the opening of the corresponding chamber, the work-piece may be disposed onto the second film 20 between the first film 10 and the second film 20. More specifically, the first film 10 is disposed between the upper surface 44 of the chamber 40 and the work-piece 30. The second film 20 is disposed between the lower surface 46 of the chamber and the work-piece 30.

While in actual practice, the first film 10 are approximately parallel mutually and having a gap therebetween. The first film 10 and the second film 20 are both clipped and fixed at the latent edge of the chamber 40, avoiding the first film 10 to contact with the second film 20 before the gas assisted imprint manufacturing process begin. Furthermore, the chamber 40 may be divided into at least three portions of upper chamber 41, middle chamber 42 and lower chamber 43 by the first film 10 and the second film 20. While in process, the upper chamber 41, the middle chamber 42 and the lower chamber 43 are mutually air tightened.

The upper chamber 41, the middle chamber 42 and the lower chamber 43 respectively having a corresponding value 47, value 48 and value 49 installed therewith, while each of the valves is capable of allowing the upper chamber 41, the middle chamber 42 and the lower chamber 43. Furthermore, each of the valves may be turned on or off in accordance with the requirement of user while each of the valves may respectively connected with a first pressure source G1, a second pressure source G2 and a third pressure source G3. In the present embodiment, the first pressure source G1 and the second pressure source is respectively connected to the upper chamber 41 and the lower chamber 43 via the valve 47 and valve 49 and provides a first pressurized fluid 50 and second pressurized fluid 60 thereto.

More specifically, in the present embodiment, the first pressure source G1 and the second pressure source G2 refer to a compressor or an air tank capable of providing pressurized fluid. The said air tank may contain liquid form air. In another hand, the third pressure source G3 connects to the middle chamber 42 via the valve 48 to provide negative pressure. It worth a mention that, the third pressure source G3 is not necessarily required in the present invention, the middle chamber 42 may be connected to the external spacing via the valve 48 while needed so as to exhaust the fluid therein. Furthermore, the third pressure source G3 is not limited to provide the negative pressure, the third pressure source G3 may also provide a certain amount of positive pressure in accordance with the requirement of the user so as to provide a resistant force against the first pressurized fluid 50 and the second pressurized fluid 60. Meanwhile, while the work-piece 30 is disposed on the surface of the second film corresponding to the middle chamber 42, the chamber 40 shall be closed thereafter as shown in the FIG. 3A.

Please refer to FIG. 3B, after closing and locking the chamber 40, a first pressurized fluid 50 and a second pressurized fluid 60 can respectively be inputted into the upper chamber 41 and lower chamber 43 via the valve 47 and the valve 49 so as to deform the first film 10 and the second film 20 toward the work-piece 30. Meanwhile, a first pressure F1 and a second pressure F2 are applied to the surface of the work-piece 30 respectively. Furthermore, after the deformation, the first film 10 and the second film 20 may respectively covering the first side 31A and the second side 31B of the work-piece 30, in order to evening the force applying onto the different portion of the work-piece, overcoming the problem existed in the prior art. In another way, while a pressure is applied to work-piece 30, the middle chamber 42 may be compressed and the fluid disposed therein may be exhausted via the valve 48.

Moreover, in order to measure the pressure of the pressurized fluid in the upper chamber 41 or the lower chamber 43, the user may optionally install a pressure meter at the corresponding valve so as to display the internal pressure in the upper chamber 41 and the lower chamber 43. Meanwhile, the present invention may further comprises an external fixing device (not depicted in the figure), such as a hydraulic device, may be utilized to provide a vertical force to the chamber 40 so as to clip the first film 10 and the second film by the chamber 40 so as to fix the relative position therebetween. Furthermore, the present invention may further comprises at least one heating modules 70, the heating modules 70 may be disposed at the valve 47 and the valve 49 so as to heat the fluid that pass therethrough. However, the heating module 70 may also be disposed at any other position of the present invention so as to heat the work-piece 30, the chamber 40, the first pressurized fluid 50, the second pressurized fluid 60 or any other member of the present system directly. For example, the heating module 70 may be disposed in the upper chamber 41, middle chamber 42 or the lower chamber 43.

Furthermore, the pressure apply on the surface of the work-piece 30 may be adjusted by controlling the pressure of the first pressurized fluid 50 and the second pressurized fluid 60 correspondingly since the pressure of pressurized fluid in the upper chamber 41 or the lower chamber 43 are proportional with the pressure applied to the surface of the work-piece 30. It worth a mention that, in the process of the present invention, lower the difference between the pressure of the pressurized fluid in the upper chamber 41 and the lower chamber 43, better the performance of the present invention. Furthermore, the said fluid may refer to air, gas form nitrogen, gas form carbon dioxide or any other fluid that is potentially be utilized as the pressurized fluid. Meanwhile, the type of the valves, the design of the flow channel, the choice of pressurized fluid and the pressure of the fluid may refer to the prior art and shall be herein omitted therein for the clarity of the specification.

In summary, the present invention of gas assisted imprint system may comprises a first chamber (refer to the said upper chamber 41) and a second chamber (refer to the said lower chamber 43). The first chamber is connected with a first pressure source G1 and having a first opening (not labeled in the figure) covered with a first flexible film (first film 10) so as to seal the first chamber and form a sealed spacing therein. The second chamber connects with a second pressure source G2 and having a second opening (not labeled in the figure) covered with a second flexible film (second film 10) so as to seal the second chamber and form a sealed spacing therein.

Furthermore, an accommodating spacing, corresponding to the said middle chamber 42 is formed between the first flexible film and the second flexible film for accommodating the work-piece therein. Furthermore, the accommodating spacing may be airtight to the first chamber and the second chamber by the first film and the second film. It worth a mention that the first pressure source G1 and the second pressure source G2 may, but not limited to, be two independently pressure sources. However, the first pressure source G1 and the second pressure source G2 may refer to two mutually connected ports connected with a common pressure source.

In another way, the accommodating spacing is a sealed chamber connected with a third pressure source G3 so as to provide a positive pressure or negative pressure. The first flexible film and the second flexible film are deformed by the pressure provided by the first pressure source and the second pressure source so as to apply a force to the surface of the working-piece. As previously described, the force applied on the surface of the working-piece by the first flexible film and the second flexible film is smaller than the average yield strength of the working-piece respectively. The yield strength refers to the total average of the whole work-piece. For example, while the work-piece is composed of a steel column and a plastic material layer formed thereon, the total average yield strength thereof refers to the sum of the first product and the second product divided by the total volume of the whole work-piece. The said first product refers to the product of volume and the unit yield strength of the steel column. The said second product refers to the product of volume and the unit yield strength of the plastic material.

Furthermore, apart from the gas assisted imprint system 1, the present invention further discloses a gas assisted imprint manufacturing process, which the process is corresponding to the gas assisted imprint system 1 and the description thereof may be applicable to the process. While in actual practice, the gas assisted imprint manufacturing process of the present invention comprises a plurality of steps as following described. Firstly, fix the first film 10 and the second film 20 with the edge of the chamber 40 so as to hang the center portion of the films into the chamber 40 so as to divide the chamber 40 into the upper chamber 41, a middle chamber 42 and a lower chamber 43. Then, the operator may dispose the work-piece 30 onto the second film 20 between the first film 10 and the second film 20. Subsequently, the operator may assembly the members so as to form the chamber 40. After the assembly, the upper chamber 41, the middle chamber 42 and the lower chamber 43 are mutually air tightened. Then, the operator may switch on the valves corresponding to the upper chamber 41, middle chamber 42 and the lower chamber 43 so as to input a high pressure fluid into the upper chamber 41 and the lower chamber 43 respectively from the first pressure source and the second pressure source. Accordingly, the first flexible film, the second flexible film may deform toward the work-piece to cover part of the surface of the work-piece 30 evenly. Accordingly, a predetermined pressure may be well distributed to the various portion of the work-piece, therefore, the present invention can be utilized to a micro/nano scale imprint process due to the accuracy thereof.

More specifically, the present invention comprises the steps of: providing a work-piece; providing a first chamber (corresponding to the upper chamber 41), the first chamber is connected with a first pressure source and having a first opening; providing a second chamber (corresponding to the lower chamber 43), connected with a second pressure source, the second chamber having a second opening; providing a first film; providing a second film; covering the first opening by the first film so as to form a sealed spacing in the first chamber; covering the second opening by the second film so as to form a sealed spacing in the second chamber and form an accommodating spacing; the accommodating spacing being formed between the first flexible film and the second flexible film for accommodating the work-piece; disposing the work-piece into the accommodating spacing; and utilizing the first pressure source and the second pressure source to provide a positive pressure to the first flexible film and the second flexible film respectively so as to deform the first flexible film and the second flexible toward the working-piece to apply a pressure thereto respectively. The accommodating spacing is air tighten and connects with a third pressure source.

It worth a mention that, the first pressure source and the second pressure source provides a positive pressure and the third pressure source provides a negative pressure. Furthermore, the force applied on the surface of the working-piece by the first flexible film and the second flexible film is smaller than the average yield strength of the working-piece respectively.

In summary, the main difference between the present invention and the prior art is that, the prior art utilizes a rigid platform to load the work-piece thereon, therefore, at least part of the work-piece is not be covered by the pressing film. In contrast, the present invention utilized a second film to replace the rigid platform of the prior art, accordingly, by replacing the rigid platform by the film, the entire surface of the work-piece could be covered and pressed evenly. It should be mentioned that, by the process of the present invention, work-piece having various shapes may also be processed. Furthermore, the present invention may, but not limited, to be utilized to the surface treatment or manufacturing process of the cardiovascular tube shaped stent, solving the long lasted problem exist in the prior art.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

Furthermore, It will be understood that when an element is referred to as being “connect” or “on” another element, it can be directly on the other element or intervening elements may be present therebetween. In contrast, when an element is referred to as being “contact” or “directly on” another element, there are no intervening elements present.

It will be understood that, although the terms “first,” or “second,” may be used herein to describe various elements or components, these elements or components should not be limited by these terms. These terms are only used to distinguish one element, component or region from another element or component. Thus, “a first member,” or “component,” discussed below could be termed a second element or component without departing from the teachings herein.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation illustrated in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented and the spatially relative descriptors used herein interpreted accordingly.

Finally, although the present invention has been illustrated and described with reference to the embodiment thereof, it should be understood that it is in no way limited to the details of such embodiment but is capable of numerous modifications within the scope of the appended claims.

1. A gas assisted imprint system, utilized to process an imprint process to a work-piece, the gas assisted imprint system comprising:
a first chamber, connected with a first pressure source, the first chamber having a first opening covered with a first flexible film for sealing the first chamber; and
a second chamber, connected with a second pressure source, the second chamber having a second opening covered with a second flexible film for sealing the second chamber;
wherein, an accommodating spacing is formed between the first flexible film and the second flexible film for accommodating the work-piece.

2. The gas assisted imprint system of claim 1, wherein the accommodating spacing is an airtight chamber connected to a third pressure source.

3. The gas assisted imprint system of claim 2, wherein the first pressure source and the second pressure source provide a positive pressure to the first chamber and the second chamber respectively, the third pressure source provides a negative pressure to the third chamber.

4. The gas assisted imprint system of claim 1, wherein the first flexible film and the second flexible film are respectively deformed and mutually connected by pressures from the first pressure source and the second pressure source so as to apply a pressure to the corresponding surfaces of the working-piece.

5. The gas assisted imprint system of claim 4, wherein the forces applied on the surface of the working-piece from the first flexible film and the second flexible film are respectively smaller than the average yield strength of the working-piece.

6. A gas assisted imprint manufacturing process, comprising the following steps of:
providing a work-piece;
providing a first chamber, connected to a first pressure source, the first chamber having a first opening;
providing a second chamber, connected to a second pressure source, the second chamber having a second opening;
providing a first film;
providing a second film;
sealing the first chamber by covering the first opening by the first film;
sealing the second chamber by covering the second opening by the second film so as to form an accommodating spacing between the first flexible film and the second flexible film for accommodating the work-piece therein;
disposing the work-piece into the accommodating spacing; and
utilizing the first pressure source and the second pressure source to respectively provide a positive pressure to the first chamber and the second chamber for deforming and connecting the first flexible film and the second flexible film so as to process the imprint process by respectively applying a pressure to the surfaces of the work-piece.

7. The gas assisted imprint manufacturing process of claim 6, wherein the accommodating spacing is air-tighten and connected to a third pressure source.

8. The gas assisted imprint manufacturing process of claim 7, wherein the first pressure source and the second pressure source respectively provides a positive pressure, the third pressure source provides a negative pressure.

9. The gas assisted imprint manufacturing process of claim 6, wherein the forces applied on the surface of the working-piece from the first flexible film and the second flexible film are respectively smaller than the average yield strength of the working-piece.
